(19) United States
(12) Patent Application Publication
(10) Pub. No.: US 2026/0299993 A1
(43) Pub. Date: Oct. 1, 2026

(54) INCREASING RELIABILITY AND PERFORMANCE OF CONTROL PLANE TRAFFIC FOR OPTICAL LANE MULTIPLEXING

(71) Applicant: VIAVI SOLUTIONS INC., Chandler, AZ (US)

(72) Inventor: Jyotikumar Menon, Clarksburg, MD (US)

(73) Assignee: VIAVI SOLUTIONS INC., Chandler, AZ (US)

(21) Appl. No.: 19/093,549

(22) Filed: Mar. 28, 2025

(51) Int. Cl. G06F 9/48; G06F 9/30

(52) U.S. Cl. CPC G06F 9/4818; G06F 9/3009

(57) ABSTRACT

A host controller of a portable testing device enables stochastic scheduling of control messages to reduce data lag and prevent service interruptions. When a thread has a control message to be communicated, the host controller sets the priority of the thread in the control plane to a randomly selected value from a predetermined range. The randomly selected value is higher than the priority that would have been set for the thread under normal priority processing. When the control message is communicated, the priority of the thread is reset to normal priority.

### BACKGROUND

Data communication networks and data centers enable data and content sharing and provide storage and backup for redundancies. Data centers typically house computing and storage resources for applications, data, and content. A data network typically includes various electronic equipment to support network communication(s). The electronic equipment generally connects to wireline networks, which may be comprised of fiber optic cables and coaxial cables.

During the operation of the communication network, various issues may arise that may require servicing. These issues may pertain to installation, preventative and remedial maintenance, testing and analyzing network communication, and testing network integrity and quality. With proper equipment and training, modern data communication networks may be serviced by a technician, thereby reducing the need for an on-site engineer.

### BRIEF DESCRIPTION OF THE DRAWINGS

Features of the present disclosure are illustrated by way of examples shown in the following figures. In the following figures, like numerals indicate like elements, in which:

FIG. 1 shows a block diagram of the architecture of a portable, network testing device according to an example of the present disclosure;

FIG. 2 shows optical lane bit multiplexing in accordance with an example;

FIG. 3 shows a representation of the classical queueing system;

FIG. 4 shows a block diagram of some of the processes controlled by a host controller of the testing device in accordance with some examples;

FIG. 5 shows a representation of stochastic scheduling in accordance with an example;

FIG. 6 shows a flowchart of the steps for testing a high bandwidth network in accordance with an example;

FIG. 7 shows a block diagram of Universal Serial Bus (USB) abstractions of the components of the testing device in accordance with an example; and

FIG. 8 illustrates a perspective view of a modular, portable data network testing device, according to an example.

### DETAILED DESCRIPTION

For simplicity and illustrative purposes, the present disclosure is described by referring mainly to examples thereof. In the following description, details are set forth in order to provide an understanding of the present disclosure. It will be readily apparent, however, that the present disclosure may be practiced without limitation to these details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but is not limited to, and the term “including” means including but not limited to. The term “based on” means based at least in part on.

Data networks enable the sharing of data and content across the globe. Data networks include data centers that typically house various electronic equipment to support network communication(s). Portable testing devices can be used by technicians to carry out diagnostic, remedial, and maintenance work on the data networks, data centers, and other data transmission or reception points. A test application can be executed by a modular, portable testing device. The test application can run a range of tests and measurements that may include without limitation, tests for insertion loss, optical return loss, and fiber length, a fiber inspection test on cables of a fiber or cables for a bulkhead, a Cable and Antenna Analyzer (CAA) test, and a Common Public Radio Interface (CPRI) test, etc. The portable testing devices are capable of testing networks of various capacities from 1 Gigabit per second (Gbps) to 800 Gbps. Further developments in fiber networks have resulted in data exchanges of the order of Terabits per second (Tbps) to accommodate data centers supporting large Artificial Intelligence (AI) projects. To test communication networks handling high bandwidth data, the testing device needs to be upgraded accordingly.

One of the constraints on the testing devices is the limited availability of power connections in large data centers. As a result, the portable testing devices have their power sources, such as batteries. However, the power requirements need to be balanced with the portability of the testing device. Furthermore, testing high bandwidth data networks requires that the testing device includes additional hardware such as an additional Field Programmable Gate Array (FPGA). Additionally, testing high bandwidth data networks can cause the testing device to heat up, which again places greater demands on the power source to cool the testing device. However, both factors, including additional hardware and larger power sources, increase the size of the testing device, thereby affecting its portability. Part of the solution to maintain portability includes increasing the capacity of the testing device while minimizing additional hardware onboard the testing device. Such an increase in capacity can be achieved via optical lane bit multiplexing and configuring the portable testing device with different removably connectable modules. An example of the removably connectable modules includes gearboxes. A gearbox chip mirrors the functions of gears in automobiles so that sixteen (16) optical lanes at 50 Gbps from the FPGA on board the testing device are bit multiplexed into eight (8) lanes at 100 Gbps by the gearbox.

While optical bit multiplexing in the data plane increases the data handling capacity of the portable testing device thereby enabling testing of high bandwidth networks, the control messages for the optical bit multiplexing in the data plane for the various control processes are managed via conventional message queue mechanisms e.g., selection of messages for processes with minimal virtual runtime e.g., implemented by the Completely Fair Scheduler (CFS) of the Linux™ kernel. However, such classical queuing mechanisms result in the delay of control message transmissions, thereby causing disruptions to data services. This delay is further exacerbated when multiple message queues are used for controlling the various hardware components of the portable testing device.

Disclosed herein are examples where the queuing system implements stochastic scheduling to reduce the delays in the control plane to enable the portable testing device to handle high-speed data without lag. In an example, the portable testing device is programmatically configured at the kernel level to implement stochastic scheduling. The priorities of various threads are manipulated to enable control message packets on the threads to be transmitted in an order different from the order assigned via the normal scheduling (or conventional scheduling as described above), thereby minimizing the lag in the data plane. The stochastic scheduling methodology disclosed herein leverages existing hardware such as the FPGA, hence mitigating the need for additional hardware.

A portable data network testing device for testing conditions of a node within a data communication network is disclosed in accordance with an example. The processor in the testing device can execute instructions from an internal onboard memory or from an external non-transitory processor-readable medium to implement the methods disclosed herein. In addition to the host controller, the portable testing device can include a peripheral controller, the FPGA, the gearbox chipsets, the Global Navigation Satellite System (GNSS), and links such as USB connections coupled to the various hardware components. The instructions cause a host controller of the testing device to create corresponding threads for multiple control plane processes that control the multiplexed communications of different hardware units of the testing device. The global scheduling policy is set to stochastic scheduling. When it is determined that at least one of the corresponding threads carries a control message packet to be communicated, the priority of that thread is changed from normal priority to a randomly selected value from a predetermined range. The random value is higher than the normal priority value associated with the thread during normal processing. The messages on the thread are exchanged based on the random value. When the messages are processed, the priority of the thread is reset to the normal value to allow other threads to be processed in turn.

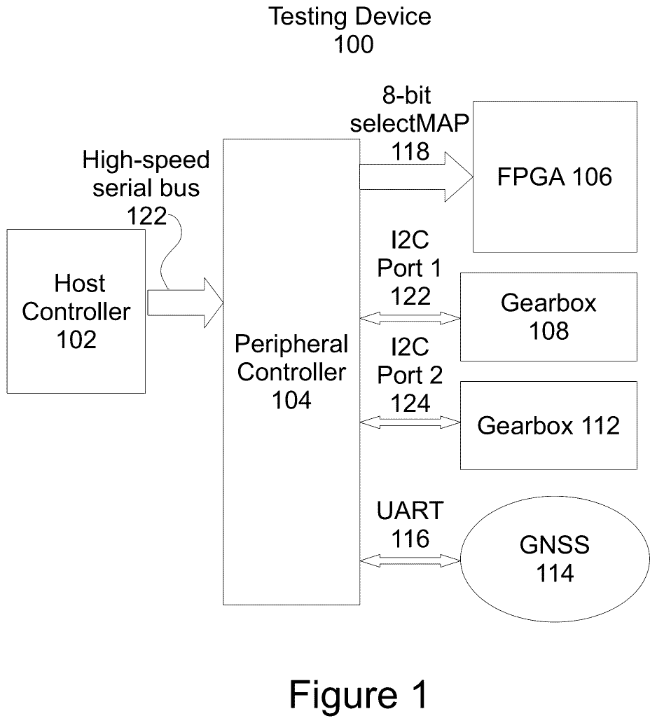

FIG. 1 shows a block diagram of the architecture of a portable data communication network testing device 100 according to an example of the present disclosure. The testing device 100 includes a host controller 102, which forms the Central Processing Unit (CPU) of the testing device 100. The host controller 102 is communicatively coupled to other hardware components of the testing device 100 via a peripheral controller 104 over a high-speed serial bus 126. In an example, the host controller 102 and the peripheral controller 104 are USB devices connected via a high-speed serial bus 126. The peripheral controller 104 is communicatively coupled to a Field Programmable Gate Array (FPGA) 106 via an 8-bit parallel interface 118 running a protocol specific to the FPGA 106 (e.g., a Xilinx selectMAP protocol if the FPGA 106 is a Xilinix FPGA). SelectMAP protocol allows an external microprocessor, e.g., the host controller 102 or the peripheral controller 104, to push a bitstream into the FPGA 106 through parallel data pins that form an 8-, 16- or 32-bit wide word, a configuration clock, and other control signals. Accordingly, the host controller 102 or the peripheral controller 104 can download FPGA bit files into the FPGA 106.

The peripheral controller 104 is also connected to two gearboxes 108 and 112 via I2C port 1 and I2C port 2, respectively. As mentioned herein, the gearboxes 108 and 112 convert or translate multiple data streams at one rate to multiple data streams at another rate by multiplexing and demultiplexing. A gearbox chipset may also include serial-to-parallel and parallel-to-serial (SERDES) data stream converters. The i2C buses, including i2C Port 1 122 and i2C Port 2 124, are used for configuration and control of the gearboxes 108 and 112 by the host controller 102, hence enabling transformation of the speeds between 400 Gbps and 800 Gbps. The Global Navigation Satellite System (GNSS) 114 is connected to the peripheral controller 104 via a Universal Asynchronous Receiver/Transmitter (UART) interface 116. UART interface 116 defines a protocol, or set of rules, for exchanging serial data between two devices, e.g., the host controller 102/the peripheral controller 104 and the GNSS 114. The UART interface 116 is used for configuring the control and results for the GNSS 114 for Global Positioning System (GPS) timing and location.

The test device 100, as mentioned herein, is used to test data networks such as fiber-optics networks ranging from 800 Gigabits per second to 1 Gigabit per second. As data centers increasingly employ the Graphics Processing Units (GPUs), high bandwidth connectivity is required to enable data exchange between the data centers. The test device 100 is built to identify defects in the high bandwidth networks. However, the test device 100 tends to heat up during high-bandwidth interactions. One methodology to reduce the heating up of the test device 100 is optical lane bit multiplexing. In an example, the host controller 102 generates control signals to create the threads for multiple control plane processes to control multiplexed communications.

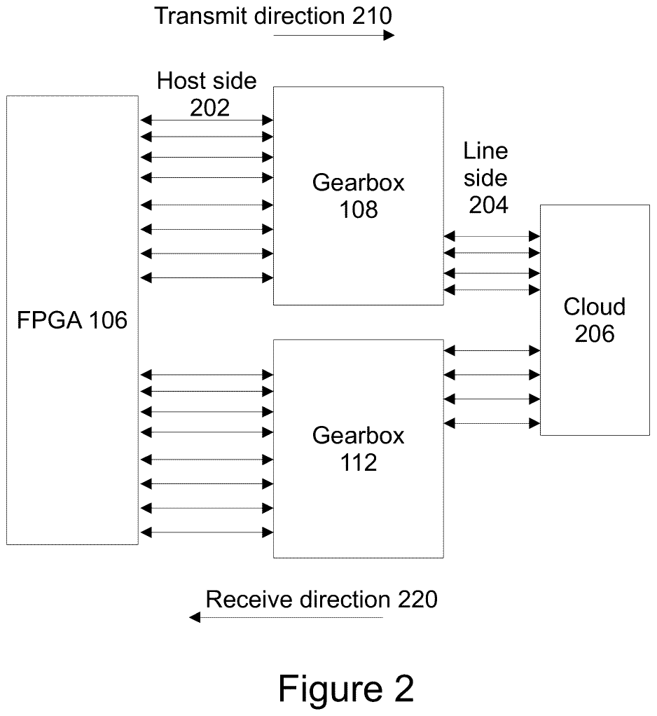

FIG. 2 shows optical lane bit multiplexing in accordance with an example. Optical lane bit multiplexing is used to increase data transmission rates by combining multiple bits of data into a single optical carrier wave. Several data streams are transmitted simultaneously over the same optical channel, each at a different time interval or frequency. Optical lane bit multiplexing helps to maximize the use of available bandwidth and improve the efficiency of optical networks. In the transmit direction 210, sixteen (16) optical lanes at 50 Gbps from the FPGA 106 on the host side 202 of the gearboxes 108/112 are bit multiplexed into eight (8) lanes at 100 Gbps on the line side 204 between the gearboxes 108/112 and an external cloud provider e.g., the cloud 206 by combining two optical lanes from the host side 202 into a single optical lane on the line side 204. In the receive direction 220, the eight (8) optical lanes at 100 Gbps from line side 204 of the gearbox 112 are bit multiplexed into 16 lanes at 50 Gbps on the host side 202 of gearbox 112, going into the FPGA 106 by splitting one optical lane from the line side 204 into two optical lanes on the host side 202.

The host controller 102 exchanges control message packets with the different hardware components to control the data plane operations on the multiplexed connections. However, adopting traditional message queue mechanisms such as classical queueing for control messages on multiplexed communications results in delay of the control messages exchanged by the host controller 102 with the various hardware components of the test device 100, which in turn causes a delay in the data plane interactions as described further herein.

Multiple logical queues of communication exist on the communications channel setup between the host controller 102 and the various hardware units, such as the peripheral controller 104, the FPGA 106, the gearboxes 108, 112, etc. The multiple logical queues can be analyzed using conventional queueing theory where Kendall's notation A/S/C, is applied to characterize the queueing problem. Classical queuing theory models systems where data packets arrive at a service facility, wait for service if the facility is busy, and then receive service before leaving the system. A queuing system is characterized by the following components:
(i) Arrival Process: It is the process by which the data packets arrive at the queue. The arrival rate is typically denoted by λ, representing the average number of arrivals per unit of time. The arrival process may follow different distributions, such as Poisson, or might be deterministic.
(ii) Service Process: It is the process by which the data packets are served. The service rate is typically denoted by μ, indicating the average number of data packets serviced per unit of time. The service process is often modeled using exponential or deterministic distributions.
(iii) Queue Discipline: This defines the order in which customers are served. Common queue disciplines include First-Come-First-Served (FCFS), Priority Queuing, and Last-Come-First-Served (LCFS), etc.

Number of Servers (C): Some systems may have multiple servers, and this affects the system's performance. Queuing models pertain to systems with either a single server or multiple servers.

Kendall's notation is a standardized way to describe queuing systems and is commonly used in queuing theory. It is written as A/S/C, where each letter or symbol represents a specific characteristic of the system. A denotes the inter-arrival times, and the most common arrival processes include Markovian (Poisson arrival process), where interarrival times are exponentially distributed. S indicates the service process, and the service distribution can be Markovian with exponentially distributed service times. C represents the number of servers in the system. C=1 for single server system and C>1 for multiple server systems.

The interarrival times or the time intervals between successive packet arrivals denoted by A are independent and identically distributed according to an exponential distribution of packet arrivals represented as:

$$F ( x ) = 1 - {e}^{- λ x} . \qquad Eq . ( 1 )$$

Let the number of packet arrivals in the interval (0,t] be denoted by N(t). Then the stochastic process {N(t)|t≥0} is a Poisson process with mean rate λ.

S denotes the time intervals between successive packet processing or service processing rates that are independent and identically distributed according to an exponential distribution:

$$F ( x ) = 1 - {e}^{- μ x} . \qquad Eq . ( 2 )$$

Let the number of packet servicing intervals in the range (0,t] be denoted by S(t). Then the stochastic process {N(t)|t≥0} is a Poisson process with mean rate μ.

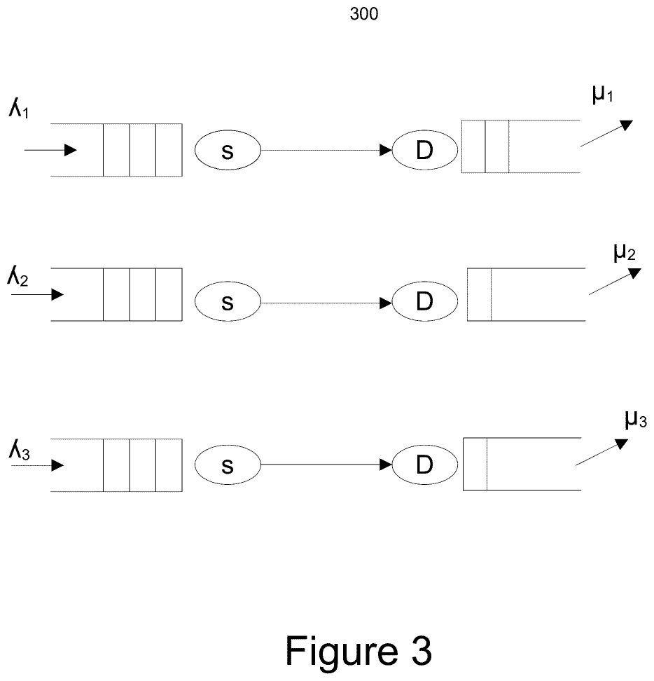

FIG. 3 illustrates a representation 300 of the classical queueing system. Particularly, representation 300 is a M/M/1 queueing model where M denotes Markovian. In the system of M/M/1 notation, 1 denotes that there is only one server where;

M (Markovian Arrival Process) denotes the arrivals that follow a Poisson process with exponentially distributed inter-arrival times. As discussed above, the average rate of arrival is denoted by λ.

M (Markovian service process) refers to the service times, which are also exponentially distributed and follow a Poisson process. The service rate is denoted by μ, and the service times are assumed to be independent.

The M/M/1 model assumes an infinite queue capacity where there is no limit to the number of entities that can wait in the system and does not account for complexities such as priorities. Therefore, if the rate of arrival of the data packets (λ) is greater than the service rate (μ), it causes packet delay. The mean delay is 1/(μ−λ). Discrete-time stochastic process {Xₙ|n=0,1,2 . . .} can be in states i=0, 1, . . . The transition probabilities Pᵢⱼ=P {Xₙ₊₁=j|Xₙ=i}, for all n>0, . . . i₀, I, j. Pij=1, I=0, 1, . . . .

For the packet arrival Poisson process, the following holds true:

N(t) is a counting process that represents the total number of arrivals that have occurred from 0 to time t [A9)=0], and for s<t, A(t)−A(s) equals the number of arrivals in the interval (s, t]. If the arrivals are considered as a Poisson process P {Tn≤s}=1−e^{-λs}·s≥0, λ is the average number of packets arriving in unit time. The service statistics are also represented as Poisson process P { [symbol] n≤s}=1−e^{-μs}·s≥0, μ is the average number of packets serviced in unit time.

The statistical packet delay calculation is shown below:

Consider m statistically identical and independent Poisson packet streams, each with λ/m packets per second and having an average transmission time of 1/μ. If the streams are merged using stochastic scheduling of the packet generation process for each stream, the average delay per packet is:

$$T = 1 / ( μ - λ ) \qquad Eq . ( 3 )$$

The packet delay on the control plane lowers the throughput on the data plane as the gearboxes 108, 112 can only be controlled by the host controller 102, which also controls other hardware of the test device 100. However, when the classical queuing system is implemented, the control messages from the host controller 102 may not be received at the gearbox(es) 108, 112 on time, causing interruptions to the data flow to the end client. Furthermore, if the transmission capacity is divided into m message queues, each modeled as an M/M/1 queue, the effect of packet delay further reduces the throughput. With an arrival rate of λ/m and a service rate of μ/m, the average delay per packet in the case of m message queues per the classical queuing system will be:

$$T = m / ( μ - λ ) \qquad Eq . ( 4 )$$

Comparing Eq. (3), which pertains to stochastic scheduling, and Eq. (4) for classical scheduling, it may be noted that the value of the mean delay T in Eq. (4) is greater than the value of T in Eq. (3), thereby implying greater delay.

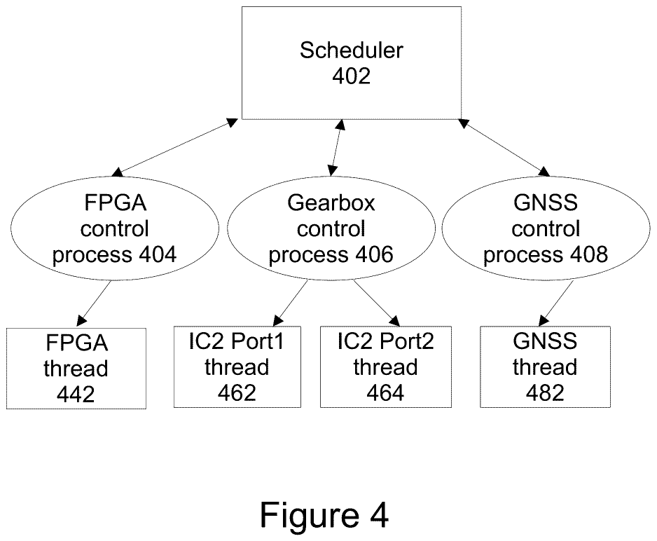

FIG. 4 shows a block diagram 400 of some of the processes controlled by the host controller 102 in accordance with some examples. In an example, the host controller 102 can be an ARM iMX8 ™ 64-bit dual-core CPU that runs the Linux™ operating system. In Linux™, the applications are run as processes with threads. A scheduler 402, e.g., a Linux™ scheduler such as the Completely Fair Scheduler (CFS), provides a traffic policing functionality to manage the creation and destruction of these processes and threads and controls which process/thread gets to execute, when to start the execution, and the length of the execution. The scheduler 402 is designed to provide fair CPU time to all processes. In an example, the scheduler 402 can process control messages via stochastic scheduling as detailed herein. The CFS is configured for a fair distribution of CPU time to processes, ensuring that each process gets a proportionate share of the CPU based on its weight and priority. In order to balance between fairness and responsiveness, the CFS operates on the concept of a virtual runtime where each process has a virtual runtime value that increases as it uses CPU time. The CFS always selects the process with the smallest virtual runtime to run next, ensuring that processes that have consumed less CPU time are given priority. This allows CFS to dynamically adjust to workloads and fairly allocate CPU time based on the process's demand and priority. The CFS uses a Red-Black Tree data structure to keep track of the processes or thread and their CPU time. The CPU time is assigned based on the priority of the process or thread and the amount of CPU time already used. The red-black tree is a self-balancing binary search tree that ensures that processes are sorted by their virtual runtimes. This allows the CFS to quickly find the process with the smallest virtual runtime to be scheduled to run next.

The scheduler 402 implements schedules for various processes, including the FPGA control process 404, the gearbox control process 406, and the GNSS control process 408, which are the main processes running on the host controller 102 for managing the various hardware units for high-speed data plane optical fabric processing. The FPGA Control process 404 runs in the FPGA thread 442, while the GNSS thread 482 is created for the execution of the GNSS control process 408. The Gearbox control process 406 for which multiple instances can be run that control multiple gearboxes 108 and 112. In the instant example, two corresponding threads, i2C Port1 Thread 462 and i2C Port 2 Thread 464, are created for the two gearboxes, 108 and 114. Processes are independent execution units with corresponding exclusive memory spaces, system resources, and scheduling contexts. Processes operate in isolation and generally do not share memory resources, and are scheduled independently of each other. Threads are more lightweight than processes and are often used for tasks requiring concurrent execution within the same application. Threads within the same process share the same memory space and are scheduled for execution by the scheduler 402. The GNSS thread 482 is created for the execution of the GNSS control process 408. The scheduler 402 is programmatically configured to implement stochastic scheduling to select threads by setting particular thread priorities instead of the default thread selection based on minimum virtual runtime.

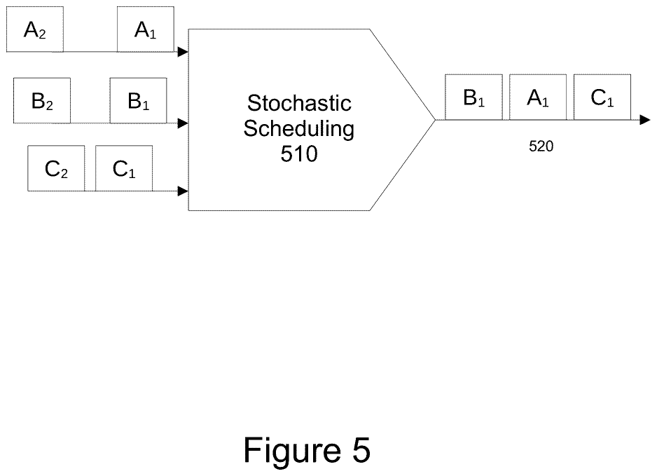

FIG. 5 shows a representation 500 of the stochastic scheduling in accordance with an example. The host controller 102, therefore, implements stochastic scheduling for the various control processes, such as the gearbox control process 406, the FPGA control process 404, and the GNSS control process 408. The performance and reliability of the traditional queuing implementation can be increased by using stochastic process scheduling. Different threads are initiated in the control plane to exchange control message packets with different hardware components of the testing device 100. Let Aᵢ (e.g., A₁, A₂, . . . etc.) represent the control message packet transmission and/or reception thread on queue 1. Similarly, Bᵢ (e.g., B₁, B₂, . . . ) and Cᵢ (C₁, C₂ . . .) represent control message packet transmission and/or reception threads correspondingly on queue 2 and queue 3. The host controller 102 sets or changes the priorities of the various processes Aᵢ, Bᵢ or Cᵢ (or specific threads associated with a process) to particular predetermined values and the control messages associated with the thread of highest priority are exchanged. In an example, one or more of the threads, Aᵢ, Bᵢ, or Cᵢ (I=1, 2, . . . ) can include control message packets that include instructions for creating the multiplexed connections between the hardware components. The arrow 510 is indicative of the schedule timeline of the threads Aᵢ, Bᵢ, and Cᵢ (I=1, 2, . . .). The CFS assigns priorities to the various threads and, based on the assigned priorities, alters the likelihood of the execution of the threads. An example temporal order of thread execution is shown at 520 as C₁, A₁ and B₁.

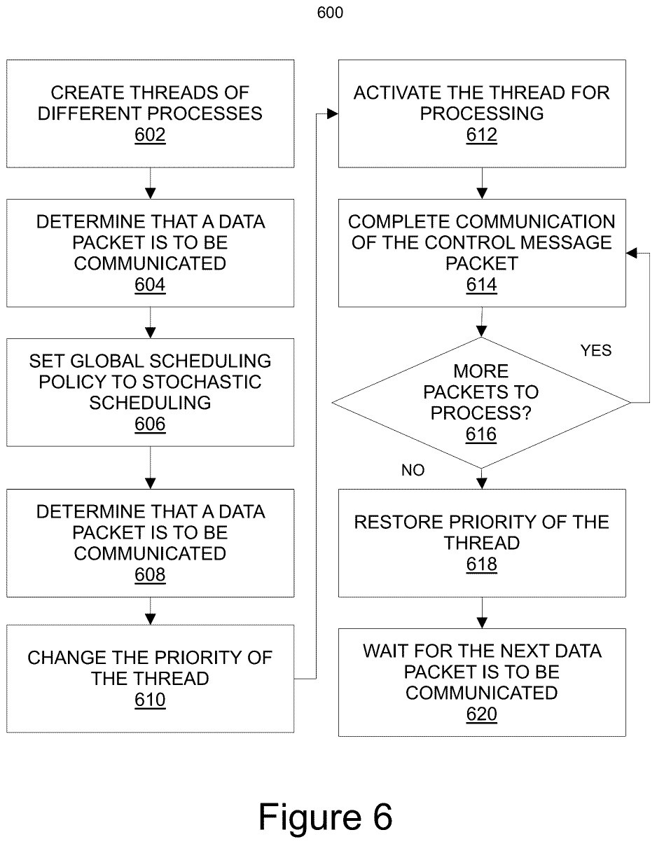

FIG. 6 shows a flowchart of a method 600 including steps for the stochastic scheduling method used in testing high bandwidth networks in accordance with an example. The method 600 is provided by way of example, as there may be a variety of ways to carry out the method described herein. Each block shown in FIG. 6 may further represent one or more processes, methods, or subroutines, and one or more of the blocks may include processor-readable instructions stored on a non-transitory computer-readable medium and executed by a processor or on an on-board memory of a processor (e.g., host controller 102) and executed by the processor or other type of processing circuit to perform one or more operations described herein. In some examples, the method 600 may be executed or otherwise performed by other systems, or a combination of systems.

At 602, the threads for different processes in the control plane are created by the kernel. For example, referring back to FIGS. 3 and 4, Aᵢ (i=1, 2, . . . ) can be threads i2C Port1 Thread 462 and i2C Port 2 Thread 464 created for the gearboxes, while Bᵢ (i=1, 2, . . . ) are threads created for the FPGA control process 404 and Cᵢ (i=1, 2, . . . ) be GNSS threads created for the GNSS control process 408. At 604, the host controller 102 determines that there is a packet to be communicated on one of the threads, e.g., thread C₁. At 606, the global scheduling policy is set to stochastic scheduling. In an example, the scheduling policy is set globally by setting a value for a variable, as shown below:

$$pTask -> schedulingpolicy = taskSchedPolicy ;$$

At 608, the host controller 102 identifies one of the threads, e.g., C₁, as having a control message packet to be communicated. At 610, the priority of the thread C₁ is changed from normal priority value to a random value selected from a predefined range. In an example, the normal priority is the priority of a thread set in accordance with the routine working of the CFS based on the virtual runtime. In an example, normal priority can have values in the range of [0,99], while the predefined range for stochastic scheduling priority can be set as [100,266]. Below is an example pseudo code for changing the priority:

```
  {
        pTask->options.priority = priority;
      min = sched_get_priority_min( pTask->schedulingpolicy );
      random = generate_random_number_range(100,266);
        schedPriority.sched_priority = priority + min + random − 1;
  DBG_LOG( DBG_OS, “Actual posix priority is %d\n”,
schedPriority.sched_priority );
    }
```

At 612, the host controller 102 activates the thread C₁ for processing based on the updated priority, and at 614, communication of the control message packet is completed. In an example, the control message packet may include instructions to create a multiplexed connection or to cause a data plane operation on a multiplexed connection between one of the hardware components of the testing device 100. At 616, the host controller 102 determines if further control message packets remain for processing on thread C1. If there are more control message packets to be processed at 616, the host controller 102 enables the communication of the control message packets at 614. If there are no further control message packets to be processed at 616, the host controller 102 moves to 618, wherein the priority of the thread C1 is restored to a normal priority value, e.g., from the range [0,99]. The host controller 102 waits at 620 for the next control message packet to be received on one of the threads. In an example, the control messages can include instructions for the host controller 102 to conduct a test on a data communication node/network.

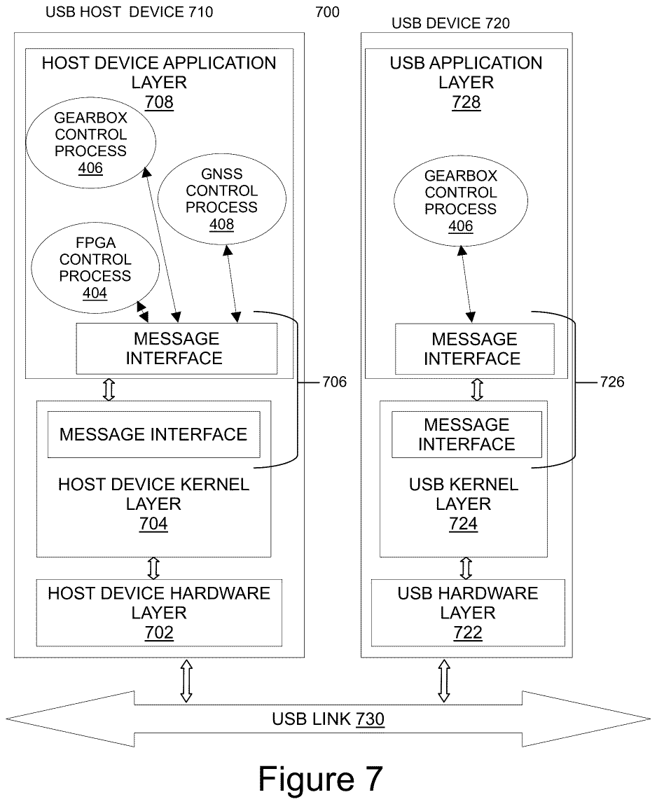

FIG. 7 shows USB abstractions 700 of a USB host device 710 connected to a USB device 720 in accordance with an example. The USB device 720 shows the gearbox control process 406 indicating that the USB device can be one of the gearboxes 108 or 112. It can be appreciated that this is only by way of illustration and that the USB device 720 can include any of the other hardware components such as the FPGA 106, GNSS 114, etc., including the corresponding control processes. The host device hardware layer 702 may include the host controller 102 which is connected to the USB system software e.g., the host device kernel layer 704 including kernel level drivers, which in turn is coupled to the host device application layer 708 via the host message interface 706. The host device application layer 708 of the USB host device 710 includes various control processes of hardware components being controlled by the USB host device 710 e.g., the FPGA control process 404, the gearbox control process 406, and the GNSS control process 408, etc. Similarly, the USB device 720 includes a USB hardware layer 722 which would include a processor chip of the gearboxes 108/112, coupled to the USB kernel layer 724 with kernel drivers. The USB kernel layer 724 in turn is communicatively coupled to the USB application layer 728 via the USB message interface 726. The USB application layer 728 of the gearbox 108/112 would include the corresponding gearbox control process 406. The USB link 730 connecting the USB host device 710 and the USB device 720 can include a USB wire or a pipe bundle, etc. and utilized operating system kernel host controller software for control and data message communications.

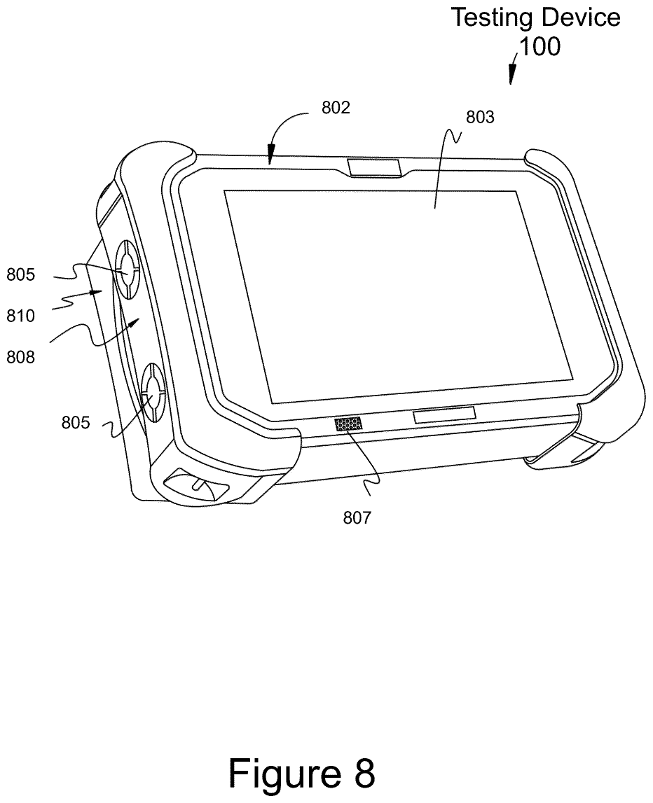

FIG. 8 illustrates a perspective view 800 of a modular, portable data communication network testing device 100 including base module 808 and I/O device 802 (which may be removably connected), according to an example of the present disclosure. The testing device 100 may be a modular hand-held device comprising removably connectable field replaceable modules for data center installation, testing, measurement, and maintenance. According to an example, the testing device 100 includes removably connectable I/O device 802, and a removably connectable base module 808.

According to an example, I/O device 802 includes a display 803 that provides user control and information. According to an example, the display 803 may be a touch screen, e.g., liquid crystal display (LCD) touchscreen. The testing device 100 provides user information including: a listing of jobs, a listing of reports to be compiled, a compilation of executed test results in a test report or test reports, and an interface control with a work station or server. Base module 808 provides hardware, software and firmware to control the testing device 100.

According to the illustrated example of FIG. 8, ventilation ports 805 are provided to the outer structure of base module 808 to facilitate internal cooling of components by way of an internal cooling unit. Loudspeaker 807 provides audio information. Base module 808 provides a structural base for the testing device 100.

According to an example, the testing device 100 may be configured in a variety of assemblies with a plurality of different removably connectable modules to support workflow and project specifications. According to the illustrated example of FIG. 8, the testing device 100 includes first expansion module 810 removably connected to the bottom of base module 808. Base module 808, similar to other modules described herein, includes a plurality of modular elements used for data center installation, testing, measurement, and maintenance. The base module 808 may be configured with a number of additional inputs and control interfaces as per requirements. Some of the modules are described briefly herein.

According to an example, base module 808 may include a PM-DL module (not shown), also known as a power meter/datalink optical module. PM-DL module and other modules described herein may be factory installed with base module 808 or one or more modules may be attached to base module 808 by a user. PM-DL module may include power meter port used to determine optical power of a fiber under test and Talkset-Datalink port (also known as a TS-PC port) for communicating voice or data with another device along an optical fiber. According to an example, base module 808 may also include a Visual Fault Locator (VFL) module, to provide detection of a visual fault location. A VFL test uses brightly visible light to check patch cords for defects and verify continuity. Similarly, the base module 808 may also include without limitation USB interfaces, audio jack, ethernet port, Direct Current (DC) input, Bluetooth module, a reset button, and other modules that improve the functionality to a technician testing the data center connections.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A testing device comprising a controller with a memory and a processing unit, wherein the memory stores processor-readable instructions executable by the processing unit to:
create corresponding threads for multiple control plane processes that control multiplexed communications of different hardware units of the testing device;
determine that at least one control message packet is to be communicated on a corresponding thread for one of the multiple control plane processes;
set scheduling policy for the corresponding thread with the at least one control message packet to stochastic scheduling;
select a random value within a predefined range as a priority for the corresponding thread associated with the at least one control message packet, wherein the random value is higher than a normal priority; and
communicate the at least one control message packet on the corresponding thread.

2. The testing device of claim 1, wherein the memory stores further processor-readable instructions that cause the processing unit to further:
reset the priority of the corresponding thread to the normal priority after the communication of the at least one control message packet.

3. The testing device of claim 1, wherein to communicate the at least one control message packet the memory stores further processor-readable instructions that cause the processing unit to further:
communicate the at least one control message packet over a universal serial bus (USB) link utilizing an operating system kernel host controller software.

4. The testing device of claim 1, wherein the different hardware units include at least a host controller, a peripheral controller connected to the host controller via a high-speed serial bus, a field programmable gate array (FPGA), at least one gearbox and a Global Navigation Satellite System (GNSS) control coupled to the host controller via the peripheral controller.

5. The testing device of claim 4, wherein the memory stores further processor-readable instructions that cause the processing unit to further:
cause a data plane operation on a multiplexed connection between the FPGA and an external cloud provider via the communication of the at least one control message packet.

6. The testing device of claim 5, wherein the gearbox enables the communication of the at least one control message packet by the FPGA from the external cloud provider.

7. The testing device of claim 6, wherein a connection from the FPGA to the at least one gearbox includes sixteen (16) optical lanes at 50 Gbps on transmit side.

8. The testing device of claim 7, wherein the memory stores further processor-readable instructions that cause the processing unit to further:
include in the at least one control message packet, instructions to bit multiplex the sixteen optical lanes into eight (8) optical lanes at 100 Gigabits per second (Gbps) on receive side from the gearbox to the external cloud provider.

9. The testing device of claim 1, wherein the multiple control plane processes include at least gearbox control process, field programmable gate array (FPGA) control process, and Global Navigation Satellite System (GNSS) control process.

10. The testing device of claim 1, wherein the multiple control plane processes control a test application that runs tests on fiber networks, wherein the tests include at least one of insertion loss test, optical return loss test, fiber length test and a fiber inspection test.

11. A method of testing a high bandwidth network comprising:
creating corresponding threads for multiple control plane processes that control communications of different hardware units of a testing device that tests a data communication node in the high bandwidth network;
determining that at least one control message packet is to be communicated on a corresponding thread for one of the multiple control plane processes;
setting scheduling policy for the corresponding thread to stochastic scheduling;
selecting a random value within a predefined range as a priority for the corresponding thread associated with the at least one control message packet, wherein the random value is higher than a normal priority; and
communicating the at least one control message packet on the corresponding thread; and
conducting a test on the data communication node in accordance with the at least one control message packet.

12. The method of claim 11, wherein conducting the test further comprises:
creating a multiplexed connection between a field programmable gate array (FPGA) and an external cloud provider via the communication of the at least one control message packet.

13. The method of claim 12, wherein creating the multiplexed connection further comprises:
creating the multiplexed connection between the FPGA and the external cloud provider via a gearbox chip.

14. The method of claim 11, wherein setting the scheduling policy for the thread to stochastic scheduling further comprises:
setting scheduling policy for the corresponding thread to stochastic scheduling programmatically by selecting a value for a variable.

15. The method of claim 11, wherein the normal priority of a thread has a value ranging from 0 to 99.

16. The method of claim 15, wherein selecting a random value within a predefined range further comprises:
selecting the random value within the predefined range of 100 to 250 as the priority for one of the corresponding thread having the at least one control message packet to be communicated.

17. The method of claim 16, further comprising:
resetting the scheduling policy for the corresponding thread to normal scheduling after communicating the at least one control message packet.

18. A processor-readable medium comprising instructions that cause a processor to:
create corresponding threads for multiple control plane processes that control multiplexed communications of different hardware units of a testing device;
determine that at least one control message packet is to be communicated on a corresponding thread for one of the multiple control plane processes;
set scheduling policy for the thread to stochastic scheduling;
select a random value within a predefined range as a priority for the corresponding thread associated with the at least one control message packet, wherein the random value is higher than a normal priority; and
communicate the at least one control message packet on the corresponding thread.

19. The processor-readable medium of claim 18, wherein instructions to select the random value within the predefined range comprise instructions that cause a processor to:
select the random value within the predefined range of 100 to 250 as the priority for the corresponding thread associated with the at least one control message packet.

20. The processor-readable medium of claim 18, wherein the different hardware units include at least a host controller, a peripheral controller connected to the host controller via a high-speed serial bus, a field programmable gate array (FPGA), at least one gearbox and a Global Navigation Satellite System (GNSS) control coupled to the host controller via the peripheral controller.
